(19) United States
(12) Patent Application Publication
(10) Pub. No.: US 2009/0289600 A1
(43) Pub. Date: Nov. 26, 2009

(54) Motor-driven vehicle with electric generation capability

(75) Inventors: Chia-Ching Lin, Yuanlin Township (TW); Szu-Min Chen, Taiping City (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: King Kai Hsiang International Development Co., Ltd, Yuanlin Township (TW)

(21) Appl. No.: 12/291,100

(22) Filed: Nov. 5, 2008

(30) Foreign Application Priority Data
May 23, 2008 (TW) 097209065

(51) Int. Cl. H02J 7/14

(52) U.S. Cl. 320/134

(57) ABSTRACT

A motor-driven vehicle includes a driving system and a power supplying system. The driving system includes a motor for driving rotation of a wheel unit, and a generator for generating electric power in response to a mechanical rotary power output outputted by the motor. A control unit of the power supplying system provides electric power from one of first and second rechargeable batteries to the motor, and charges the other one of the first and second rechargeable batteries with the electric power from the generator. The control unit provides electric power from the other one of the first and second rechargeable batteries to the motor, and charges said one of the first and second rechargeable batteries upon detecting that residual power of said one of the first and second rechargeable batteries detected by a detector is less than a predetermined value.

### CROSS-REFERENCES TO RELATED APPLICATIONS

This application claims priority to Taiwanese Application No. 097209065, filed May 23, 2008, the disclosure of which is herein incorporated by reference.

### BACKGROUND OF THE INVENTION

1. Field of the Invention

The invention relates to a motor-driven vehicle with electric generation capability.

2. Description of the Related Art

FIG. 1 illustrates a conventional motor-driven vehicle 1. The conventional motor-driven vehicle 1 includes a driving system 11, and a rechargeable battery 12. The driving system 11 includes a wheel unit 111, a motor 113, and a speed change gear box 112 coupled between the wheel unit 111 and the motor 113. The motor 113 drives rotation of the wheel unit 111 through the speed change gear box 112. The rechargeable battery 12 is coupled to the motor 113 for supplying electric power thereto.

In such a configuration, frequent charging of the rechargeable battery 12 is required.

### SUMMARY OF THE INVENTION

Therefore, an object of the present invention is to provide a motor-driven vehicle that has electric generation capability.

According to the present invention, a motor-driven vehicle comprises:

a driving system including
a wheel unit,
a motor coupled to the wheel unit for driving rotation of the wheel unit and for outputting a mechanical rotary power output, and
a generator coupled to the motor for generating electric power in response to the mechanical rotary power outputted from the motor; and

a power supplying system including
a first rechargeable battery,
a second rechargeable battery,
a detector coupled to the first and second rechargeable batteries for detecting residual power of the first and second rechargeable batteries to generate a detecting signal, and
a control unit coupled to the generator and the motor of the driving system, the first and second rechargeable batteries, and the detector, the control unit being operable in one of a first mode, where the control unit provides electric power from the first rechargeable battery to the motor of the driving system, and charges the second rechargeable battery with the electric power generated by the generator, and a second mode, where the control unit provides electric power from the second rechargeable battery to the motor of the driving system, and charges the first rechargeable battery with the electric power generated by the generator.

The control unit is switched from the first mode to the second mode upon detecting that the residual power of the first rechargeable battery detected by the detector is less than a predetermined value based on the detecting signal from the detector, and is switched from the second mode to the first mode upon detecting that the residual power of the second rechargeable battery detected by the detector is less than the predetermined value based on the detecting signal from the detector.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic diagram of a conventional motor-driven vehicle; and

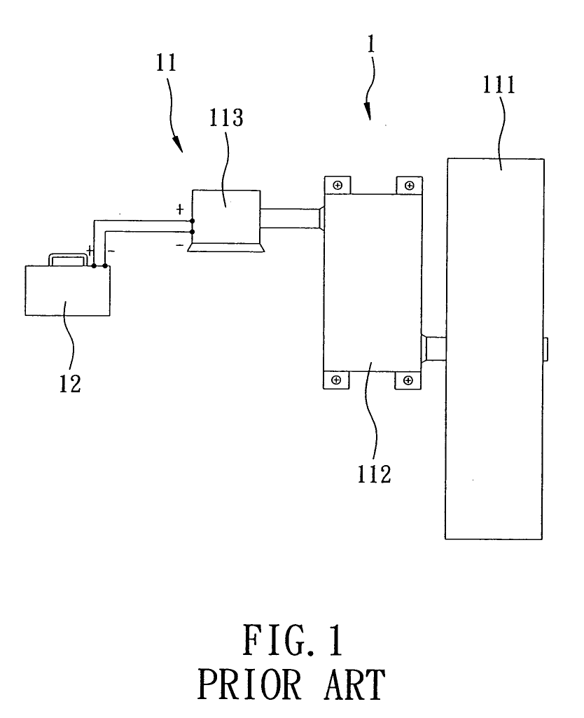

FIG. 2 is a schematic circuit block diagram showing the preferred embodiment of a motor-driven vehicle according to the present invention.

### DETAILED DESCRIPTION OF THE PREFERRED EMBODIMENT

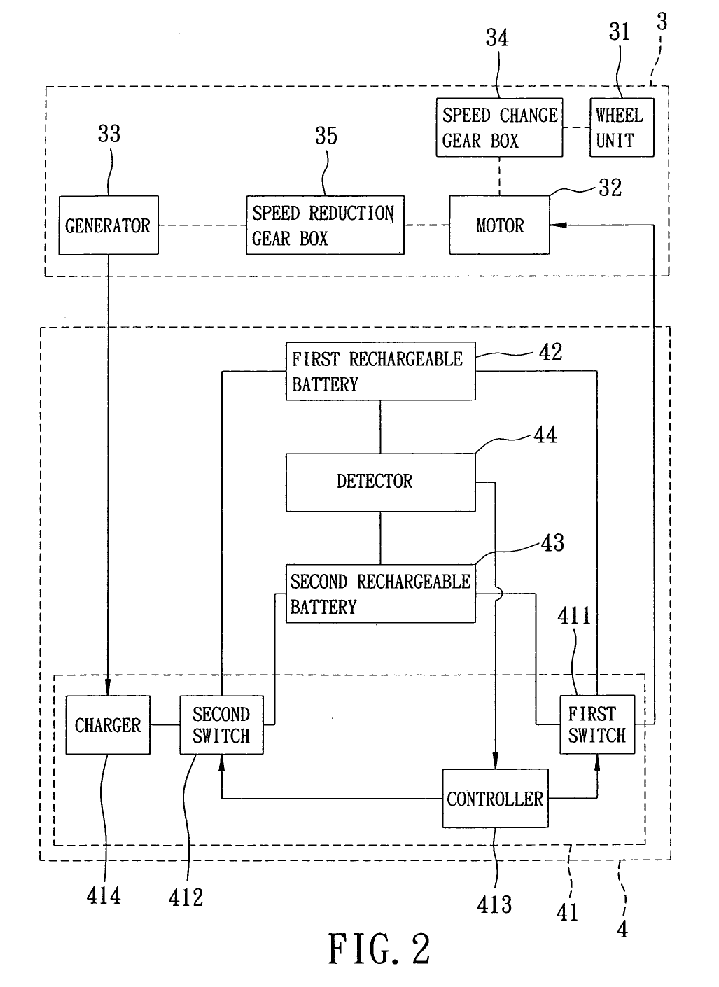

Referring to FIG. 2, the preferred embodiment of a motor-driven vehicle according to the present invention is shown to include a driving system 3 and a power supplying system 4.

The driving system 3 includes a wheel unit 31, a motor 32, a generator 33, a speed change gear box 34, and a speed reduction gear box 35. The speed change gear box 34 is coupled between the motor 32 and the wheel unit 31. The motor 32 drives rotation of the wheel unit 31 through the speed change gear box 34, and outputs a mechanical rotary power output. The speed reduction gear box 35 is coupled between motor 32 and the generator 33. The generator 33 generates electric power in response to the mechanical rotary power output outputted from the motor 32 and transmitted by the speed reduction gear box 35.

The power supplying system 4 includes a first rechargeable battery 42, a second rechargeable battery 43, a detector 44, and a control unit 41.

The detector 44 is coupled to the first and second rechargeable batteries 42, 43 for detecting residual power of the first and second rechargeable batteries 42, 43 to generate a detecting signal.

The control unit 41 is coupled to the generator 33 and the motor 32 of the driving system 3, the first and second rechargeable batteries 42, 43, and the detector 44. The control unit 41 is operable in one of a first mode, where the control unit 41 provides electric power from the first rechargeable battery 42 to the motor 32 of the driving system 3, and charges the second rechargeable battery 43 with the electric power generated by the generator 33, and a second mode, where the control unit 41 provides electric power from the second rechargeable battery 43 to the motor 33 of the driving system 3, and charges the first rechargeable battery 42 with the electric power generated by the generator 33.

In this embodiment, the control unit 41 includes a charger 414, a first switch 411, a second switch 412, and a controller 413. The charger 414 is coupled to the generator 33 of the driving system 3 for receiving the electric power therefrom. The first switch 411 is coupled to the first rechargeable battery 42, the second rechargeable battery 43 and the motor 32, and is operable to establish electrical connection between the motor 32 and one of the first and second rechargeable batteries 42, 43 therethrough. The second switch 412 is coupled to the first rechargeable battery 42, the second rechargeable battery 43 and the charger 414, and is operable to establish electrical connection between the charger 414 and one of the first and second rechargeable batteries 42, 43 therethrough. The controller 413 is coupled to the first rechargeable battery 42, the second rechargeable battery 43 and the detector 44 for receiving the detecting signal from the detector 44.

When the control unit 41 is operated in the first mode, the controller 413 controls the first switch 411 to establish electrical connection between the first rechargeable battery 42 and the motor 32 therethrough such that the electric power from the first rechargeable battery 42 is supplied to the motor 42, and controls the second switch 412 to establish electrical connection between the charger 414 and the second rechargeable battery 43 such that the charger 414 charges the second rechargeable battery 43 with the electric power generated by the generator 33. When the control unit 41 is operated in the second mode, the controller 413 controls the first switch 411 to establish electrical connection between the second rechargeable battery 43 and the motor 32 therethrough such that the electric power from the second rechargeable battery 43 is supplied to the motor 42, and controls the second switch 412 to establish electrical connection between the charger 414 and the first rechargeable battery 42 such that the charger 414 charges the first rechargeable battery 42 with the electric power generated by the generator 33.

It is noted that the control unit 41 is switched from the first mode to the second mode upon detecting that the residual power of the first rechargeable battery 42 detected by the detector 44 is less than a predetermined value based on the detecting signal from the detector 44, and is switched from the second mode to the first mode upon detecting that the residual power of the second rechargeable battery 43 detected by the detector 44 is less than the predetermined value based on the detecting signal from the detector 44.

In sum, the motor 32 of the driving system 3 operates by the electric power from one of the first and second rechargeable batteries 42, 43 while the other one of the first and second rechargeable batteries 42, 43 is charged by the electric power from the generator 33. Therefore, the motor-driven vehicle of the present invention has an enhanced power supplying capability.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. A motor-driven vehicle comprising:
a driving system including
a wheel unit,
a motor coupled to said wheel unit for driving rotation of said wheel unit and for outputting a mechanical rotary power output, and
a generator coupled to said motor for generating electric power in response to the mechanical rotary power outputted from said motor; and
a power supplying system including
a first rechargeable battery,
a second rechargeable battery,
a detector coupled to said first and second rechargeable batteries for detecting residual power of said first and second rechargeable batteries to generate a detecting signal, and
a control unit coupled to said generator and said motor of said driving system, said first and second rechargeable batteries, and said detector, said control unit being operable in one of a first mode, where said control unit provides electric power from said first rechargeable battery to said motor of said driving system, and charges said second rechargeable battery with the electric power generated by said generator, and a second mode, where said control unit provides electric power from said second rechargeable battery to said motor of said driving system, and charges said first rechargeable battery with the electric power generated by said generator;
wherein said control unit is switched from the first mode to the second mode upon detecting that the residual power of said first rechargeable battery detected by said detector is less than a predetermined value based on the detecting signal from said detector, and is switched from the second mode to the first mode upon detecting that the residual power of said second rechargeable battery detected by said detector is less than the predetermined value based on the detecting signal from said detector.

2. The motor-driven vehicle as claimed in claim 1, wherein said control unit of said power supplying system includes:
a charger coupled to said generator of said driving system for receiving the electric power therefrom;
a first switch coupled to said first and second rechargeable batteries, and to said motor of said driving system, said first switch being operable to establish electrical connection between said motor and one of said first and second rechargeable batteries therethrough;
a second switch coupled to said first and second rechargeable batteries, and to said charger, said second switch being operable to establish electrical connection between said charger and one of said first and second rechargeable batteries therethrough; and
a controller coupled to said first and second switches, and to said detector for receiving the detecting signal from said detector,
said controller controlling said first switch to establish electrical connection between said first rechargeable battery and said motor therethrough such that the electric power from said first rechargeable battery is supplied to said motor, and controlling said second switch to establish electrical connection between said charger and said second rechargeable battery therethrough such that said charger charges said second rechargeable battery with the electric power generated by said generator when said control unit is operated in the first mode,
said controller controlling said first switch to establish electrical connection between said second rechargeable battery and said motor therethrough such that the electric power from said second rechargeable battery is supplied to said motor, and controlling said second switch to establish electrical connection between said charger and said first rechargeable battery therethrough such that said charger charges said first rechargeable battery with the electric power generated by said generator when said control unit is operated in the second mode.

3. The motor-driven vehicle as claimed in claim 1, wherein said driving system further includes:
a speed change gear box coupled between said motor and said wheel unit; and
a speed reduction gear box coupled between said motor and said generator.
